(19) United States
(12) Patent Application Publication
(10) Pub. No.: US 2006/0267367 A1
(43) Pub. Date: Nov. 30, 2006

(54) Seating apparatus for use on a vehicle having a flat carrying area

(76) Inventors: David James Burgess, Warick (GB); Edward Walker Versashoor, Pynacker (NL)

Correspondence Address: Iandiorio & Teska, 260 Bear Hill Road, Waltham, MA, 02451, US

(21) Appl. No.: 10/563,530

(22) PCT Filed: Jun. 28, 2004
(86) PCT No.: PCT/GB04/02785

§ 371 Date: Jan. 4, 2006

(30) Foreign Application Priority Data
Jun. 30, 2003 (GB) 0315303.8

(51) Int. Cl. B60N 2/02

(52) U.S. Cl. 296/68.1

(57) ABSTRACT

Seating apparatus (2) for use on a vehicle (4) having a flat carrying area (6), which seating apparatus (2) comprises a frame (12) giving roll over protection to a person (14) seated on the seating apparatus (2) in the event that the vehicle (4) should roll over, at least one seat (16) mounted in the frame (12), and securing means (18) for releasably securing the seating apparatus (2) on the flat carrying area (6) of the vehicle (4) whereby the seating apparatus (2) is able to be secured on the flat carrying area (6) and removed from the flat carrying (6) as desired.

This invention relates to seating apparatus and, more especially, this invention relates to seating apparatus for use on a vehicle having a flat carrying area. The flat carrying area may be used for carrying cargo. Alternatively, the flat carrying area may be used for carrying persons This invention also relates to the vehicle when provided with the seating apparatus.

Vehicles for carrying cargo are often in the form of a truck having a driving cab and a back which forms a storage area. The back of the vehicle can be a flat back or it can be canvas-covered with drop down sides and a tail gate. There is generally no structural protection for the storage area. If the storage area is to carry persons, for example military personnel, then it is known to install bench-type seating with specific securing means securing the bench-type seating to the back of the vehicle. Sometimes, the vehicles are for carrying personnel, for example military personnel, rather than cargo. Such vehicles may be armoured military vehicles carrying military personnel on bench-type seating. Irrespective of the type of vehicle, in the event that the vehicle is involved in an accident, the persons sitting on the bench-type seating are often thrown about and they invariably suffer injury or death.

It is an aim of the present invention to obviate or reduce the above mentioned problem.

Accordingly, in one non-limiting embodiment of the present invention there is provided seating apparatus for use on a vehicle having a flat carrying area, which seating apparatus comprises a frame giving roll over protection to a person seated on the seating apparatus in the event that the vehicle should roll over, at least one seat mounted in the frame, and securing means for releasably securing the seating apparatus on the flat carrying area of the vehicle whereby the seating apparatus is able to be secured on the flat carrying area and removed from the flat carrying area as desired.

Due to the presence of the frame, the seating apparatus of the present invention gives a person sitting in the seat good protection in the event of the vehicle having an accident. The frame is particularly advantageous in the event that the vehicle should roll over, as may occur in rough terrain. In this case, the frame gives roll over protection to the person seated on the seating apparatus. The seating apparatus may be installed on any suitable vehicle. The seating apparatus is especially useful for installation on military vehicles such for example as military vehicles mainly used for carrying cargo, and armoured military vehicles mainly used for carrying persons. The seating apparatus is also advantageous in that it can easily be secured to the flat carrying area and removed from the flat carrying area. Thus the seating apparatus can be installed when desired, and removed when it is not required, for example when the flat carrying area is required as storage space for receiving cargo.

Preferably, the seat is demountable from the frame. This may facilitate carrying installation and storage of the seating apparatus. Where the seat is demountable from the frame, then the seat may be mounted by a spring bolt mechanism. Other mounting mechanisms may be employed. If desired, the seat can be permanently fixed to the frame.

Preferably, the seat is a foldable seat. If desired however the seat may be a non-foldable seat.

The frame may be able to receive from one to four of the seats. Where the seats are demountable from the frame, any required number of seats can easily and quickly be secured to the frame.

Advantageously, the frame is a modular frame which is able to be connected to at least one further similar modular frame. Thus, for example, if four frames were connected together, then with each frame being able to contain four seats, there would be a maximum of sixteen seats for carrying sixteen persons.

Usually, the securing means will secure the frame direct to the flat carrying area.

The securing means may be a quick release securing means. The securing means may be a latch and shackle quick release securing means. Alternatively, the securing means may be a plug and socket quick release securing means. Alternatively, the securing means may be a hook and socket quick release securing means. Any suitable and appropriate type of securing means may be employed, including permanent securing means and quick release securing means.

Advantageously, the frame is a foldable frame. The use of a foldable frame may facilitate installation of the frame, storage and transport. If desired however the frame may however be a non-foldable frame.

Preferably, the frame is of an open tubular construction. Other constructions for the frame may be employed.

The seating apparatus may include a stowage space underneath the seat.

The seating apparatus may include holder means for holding an object to be carried by a person sitting in the seat. The object may be a tool, a weapon or any other suitable and appropriate object.

The seating apparatus may include lateral restraint means for a person seated on the seat.

The seating apparatus may generally include a headrest. The headrest may be curved to give front-to-back and side-to-side restraint.

The seating apparatus may also include a seat belt.

As indicated above, the present invention also provides a vehicle when provided with the seating apparatus.

Embodiments of the invention will now be described solely by way of example and with reference to the accompanying drawings in which;

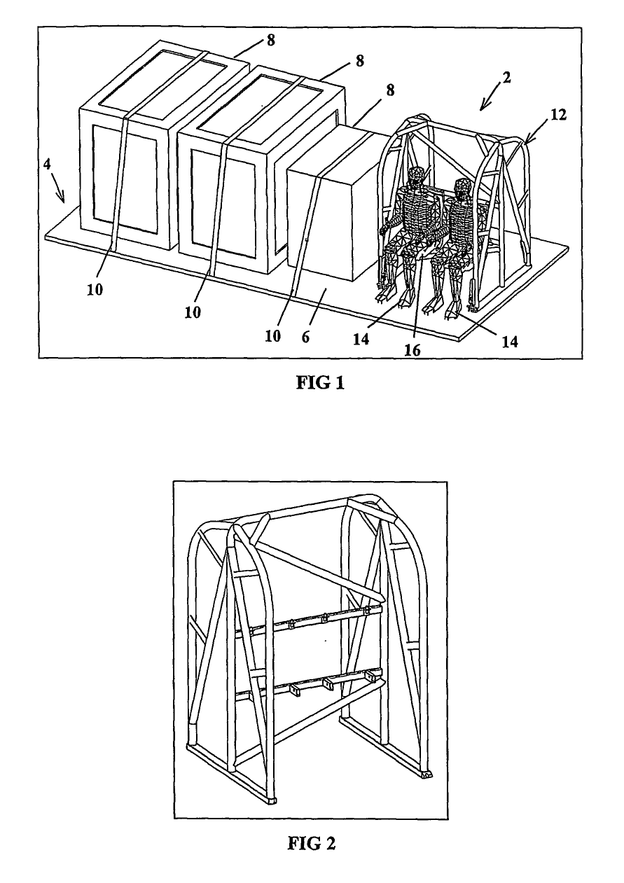

FIG. 1 shows seating apparatus of the present invention in use;

FIG. 2 shows a frame forming part of the seating apparatus shown in FIG. 1;

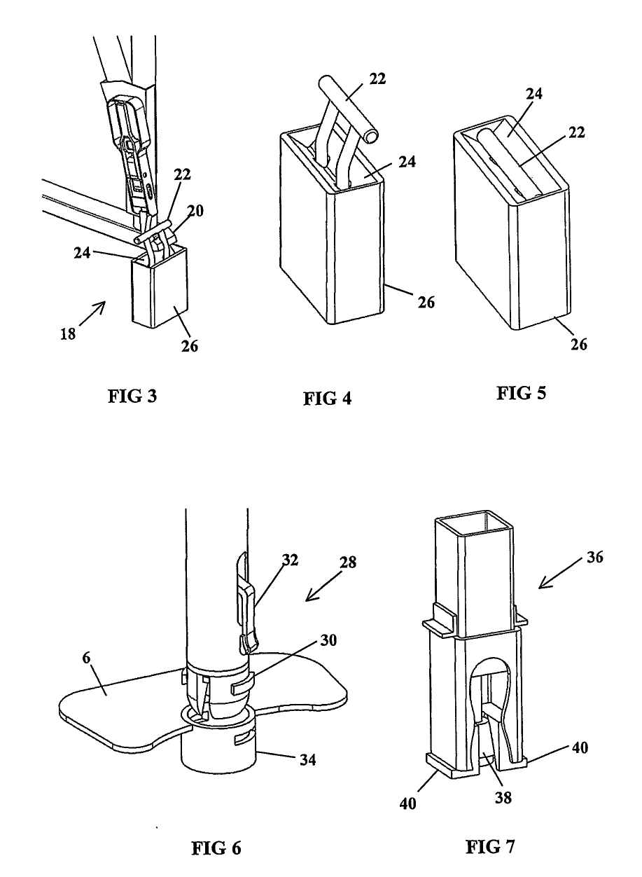

FIGS. 3, 4 and 5 show securing means forming part of the seating apparatus shown in FIG. 1;

FIGS. 6 and 7 show two alternative type of securing means to those shown in FIGS. 3-5;

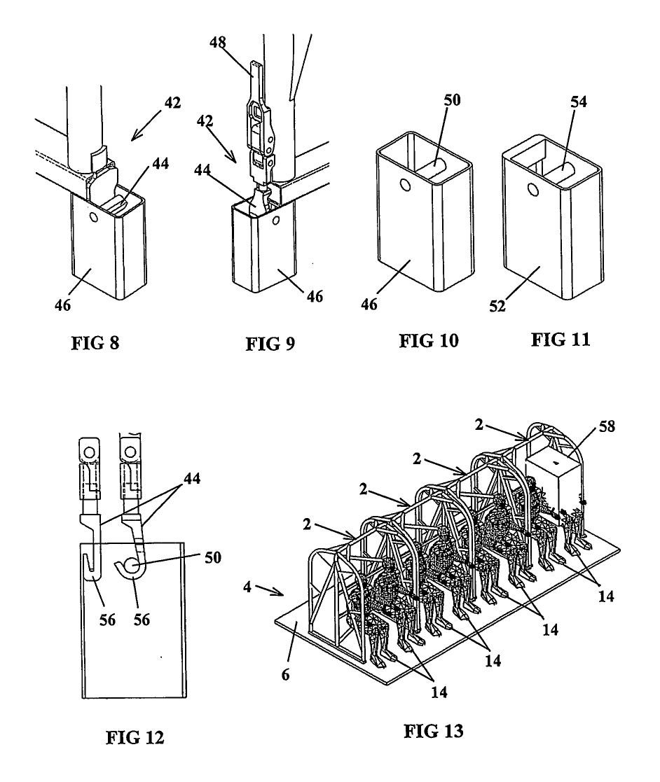

FIGS. 8-12 show further alternative types of securing means to the securing means shown in FIGS. 3-5;

FIG. 13 shows four modular frames connected together;

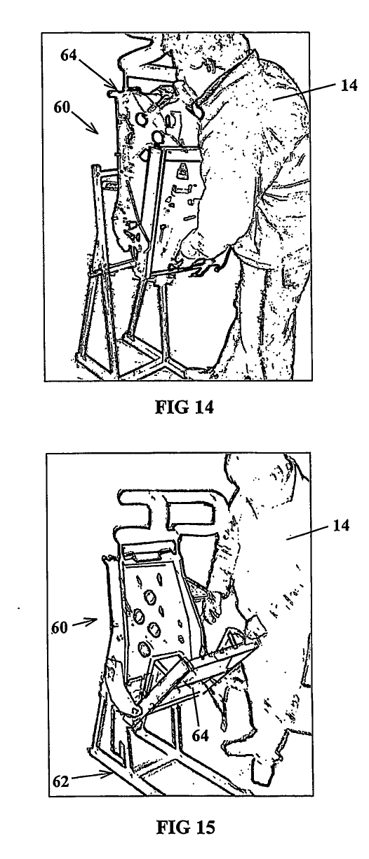

FIG. 14 shows a foldable seat which is also demountable from a seat frame.

FIG. 15 shows the seat of FIG. 14 on the seat frame and being unfolded;

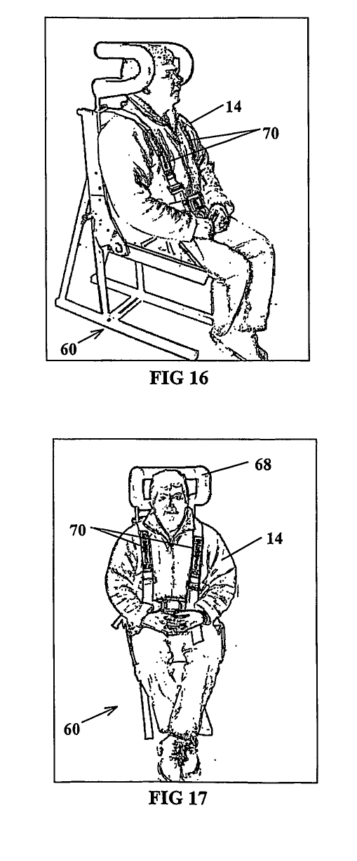

FIGS. 16 and 17 show a person sitting on the seat of FIGS. 14 and 15;

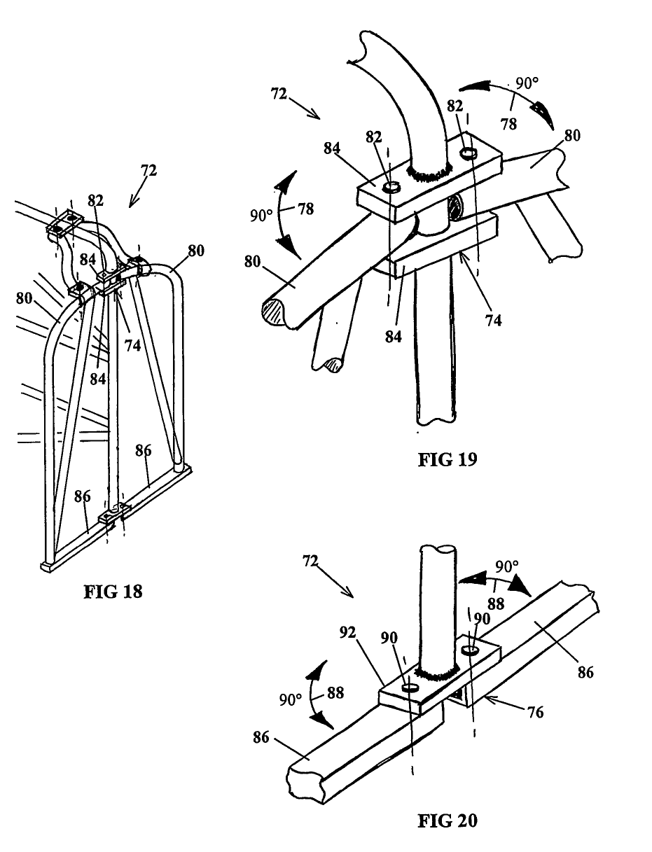

FIG. 18 shows part of a frame of the seating apparatus;

FIG. 19 shows in more detail a top joint shown in FIG. 18;

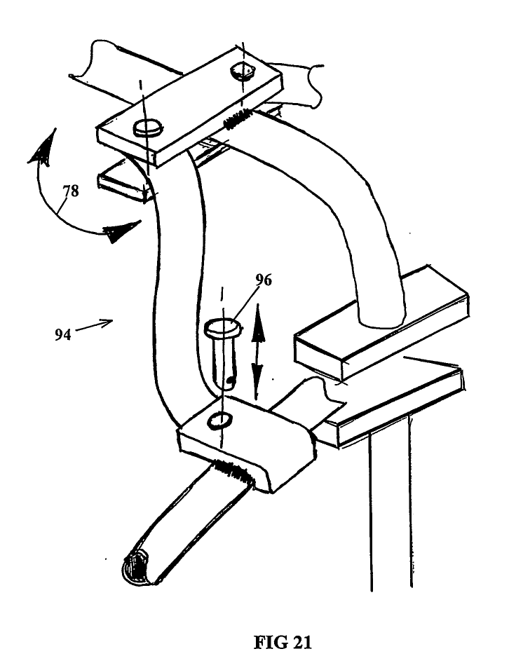

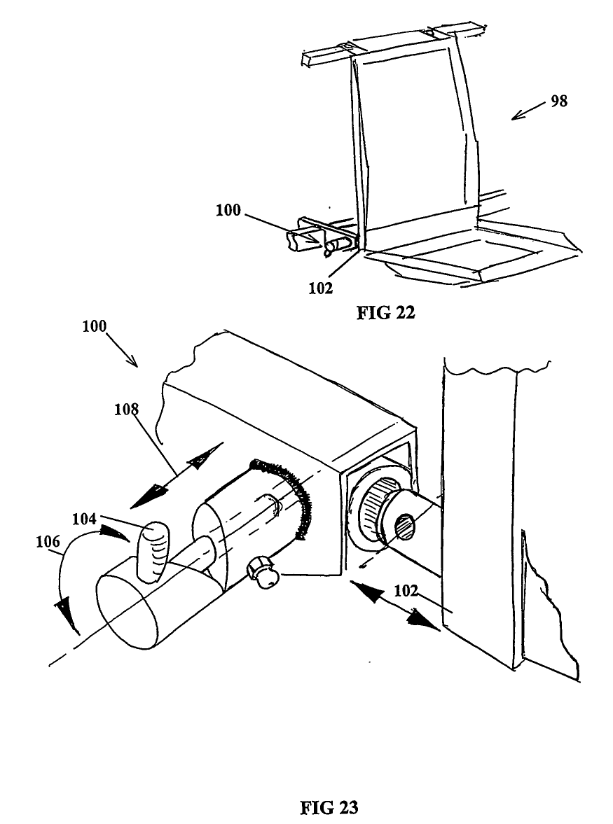

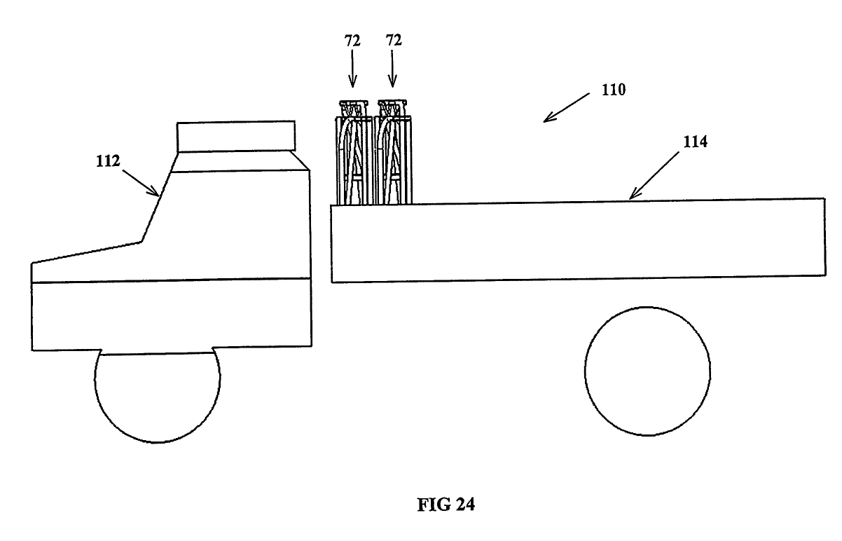

FIG. 20 shows in more detail a bottom joint shown in FIG. 18;

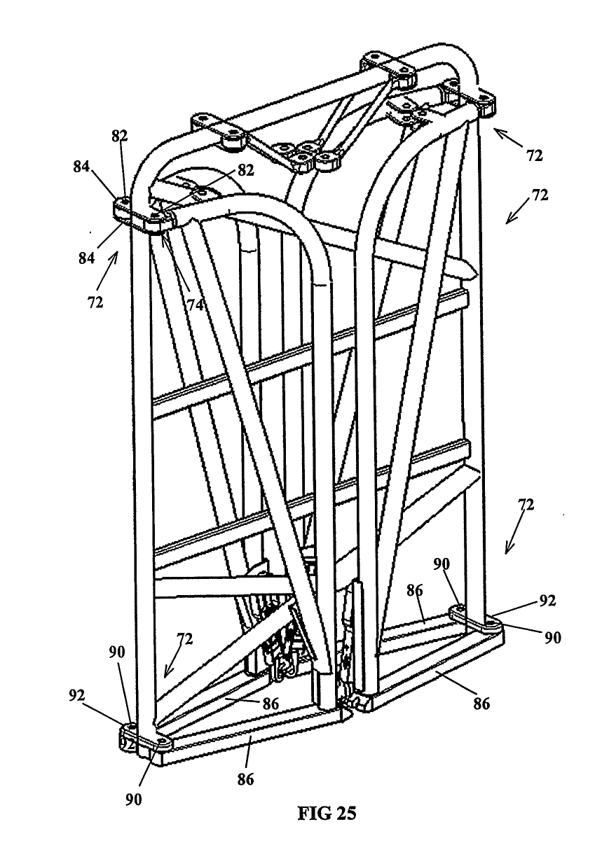

FIG. 21 shows a top joint corner bracing arrangement for a frame used in the seating apparatus;

FIG. 22 shows pictorially a seat forming part of the seating apparatus;

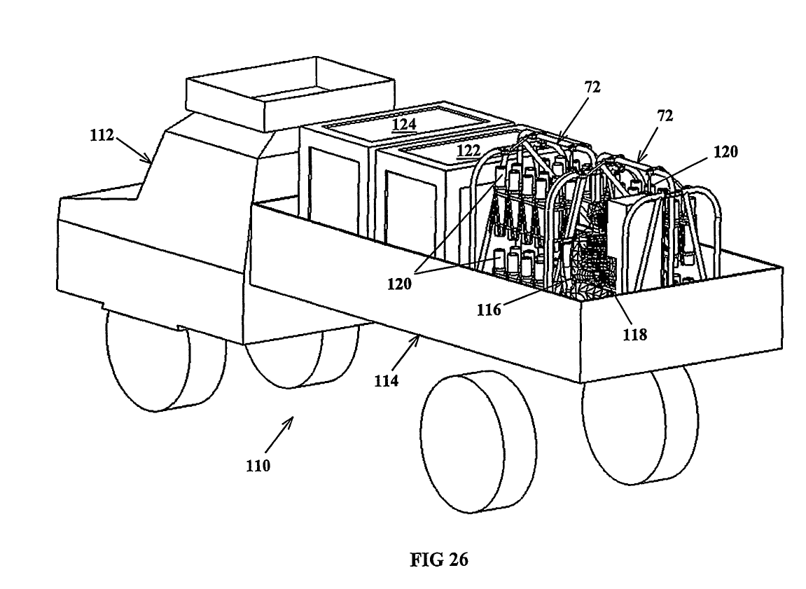

FIG. 23 shows in more detail the operation of a locking pin in its disengaged position for the seat shown in FIG. 22;

FIG. 24 is a side view of a vehicle having a driving cab and a flat back, with the flat back containing folded seating frames which have been folded flat as indicated in FIGS. 18-21, and which have had their seats removed as indicated in FIGS. 22 and 23;

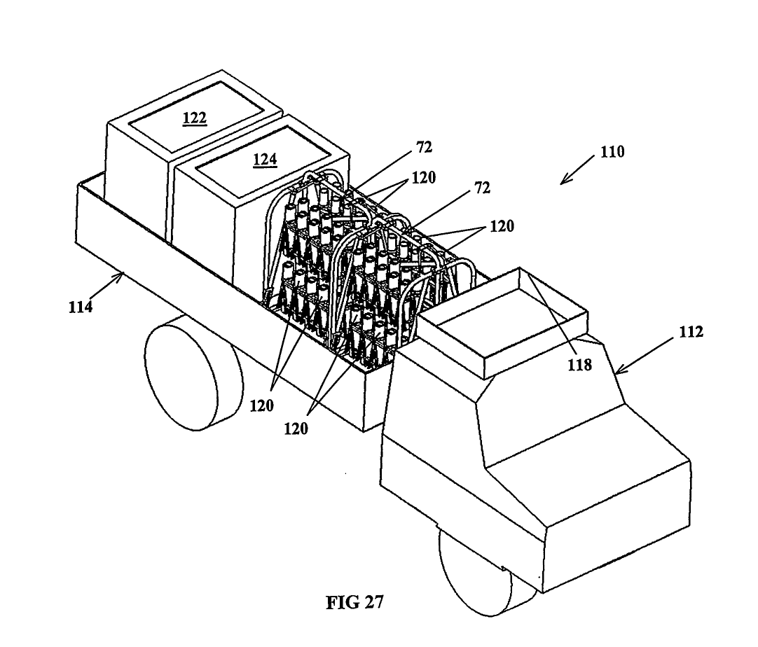

FIG. 25 shows a flat folded frame;

FIG. 26 shows a vehicle having one frame containing seating apparatus and another frame with the seating apparatus being removed and being replaced by cargo secured in position to the frame;

FIG. 27 shows the vehicle of FIG. 26 but with both frames having their seating apparatus removed and being used for carrying cargo in a secure manner;

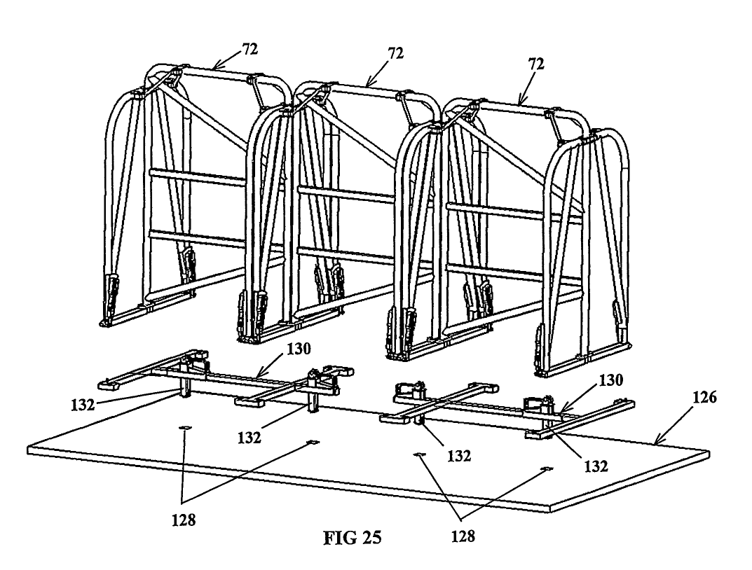

FIG. 28 is an exploded view showing how frames may be secured to a flat back of a truck utilising adaptor sub-frames;

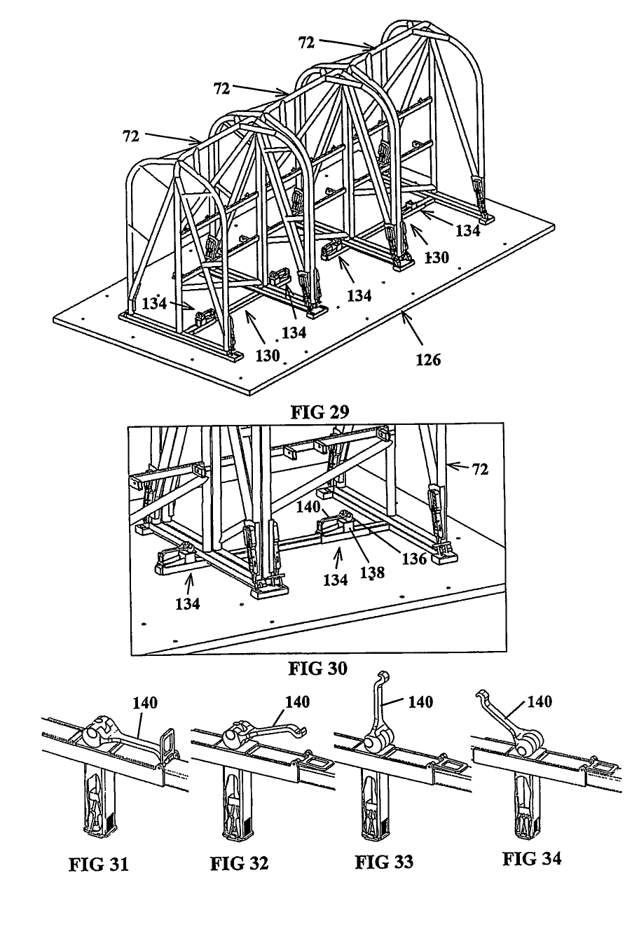

FIG. 29 is a perspective view of what is shown in FIG. 28, but in a fixed position;

FIG. 30 shows in more detail part of FIG. 29;

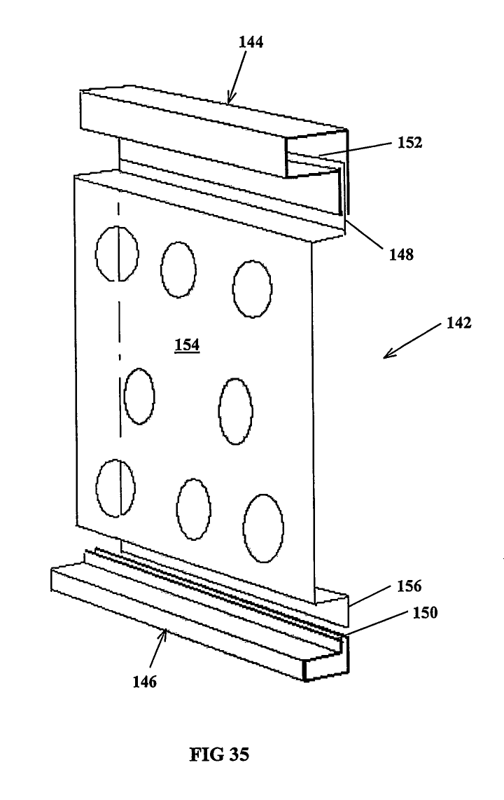

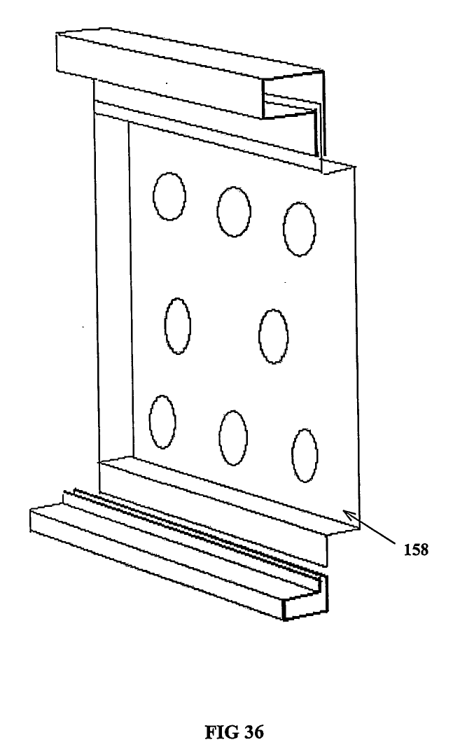

FIGS. 31-34 show the operation of a sub-frame latch shown in FIG. 30;

FIG. 35 is a perspective view of part of a backrest of a seat and in a first position; and

FIG. 36 shows the part of the backrest shown in FIG. 35 but in a second position.

Referring to FIGS. 1-5, there is shown seating apparatus 2 for use on a vehicle 4 having a flat carrying area in the form of a storage area 6 normally used for carrying cargo 8. For simplicity of illustration in FIG. 1, only the storage area 6 in the form of a flat bed back of a truck has been shown. A driving cab and wheels for the truck have not been shown since they are not central to the invention. The cargo 8 is shown secured in position on the cargo area 8 by straps 10.

The seating apparatus 2 comprises a frame 12 giving roll over protection to a person 14 seated on the seating apparatus 2 in the event that the vehicle 4 should roll over. The seating apparatus also comprises at least one seat 16 mounted on the frame. As shown in FIG. 1, there are two seats 16 for two persons 14.

The seating apparatus 2 further comprises securing means 18 for releasably securing the seating apparatus 2 on the storage area 6 of the vehicle 4. Because the securing means 18 is releasable, the seating apparatus 2 is able to be secured on the storage area 6 and removed from the storage area 6 as desired. Thus when the storage area is to carry one or more persons 14, then the seating apparatus can be installed. If one or more persons 14 are not to be carried, then the seating apparatus 2 can be removed and the storage area 6 then is able to be used to its maximum extent for carrying the cargo 8.

The seat 16 is demountable from the frame 12. The seat is mounted by a spring bolt mechanism. The seat is a foldable seat.

The frame 12 is able to receive up to four of the seats 16, with two seats 16 being on one side of the frame 12 and two seats 16 being on the other side of the frame 12.

The frame 12 is a modular frame which is able to be connected to at least one further similar modular frame.

The securing means 18 secures the frame to the storage area. The securing means 18 is a quick release securing means 18 as can be appreciated from FIGS. 3, 4 and 5. More specifically, the securing means 18 is a latch and shackle quick-release securing means 18 having a latch 20 and a shackle 22. FIG. 4 shows the shackle 22 in a deployed condition. FIG. 5 shows the shackle 22 in a rest condition. In the rest condition, the shackle 22 rests in V-shaped recess 24. This recess may be of other shapes if desired. As shown in FIGS. 3, 4 and 5, the shackle 22 is provided in a box 26. The shackle 22 could alternatively be secured to a part of the storage area 6, for example a strengthening beam running underneath the part of the storage area 6 shown in FIG. 1.

FIG. 6 shows a plug and socket quick release securing means 28 which can alternatively be employed to the securing means 18 shown in FIGS. 3, 4 and 5. As shown in FIG. 6, a plug 30 is raised and lowered by a lever 32. When lowered, the plug 30 fits in a socket 34 underneath the storage area 6.

FIG. 7 shows an alternative plug and socket quick release securing means 36 which is alternative to the securing means 28 shown in FIG. 6. In FIG. 7, it will be seen that a plug or cam member 38 is able to expand two halves of a plug 40.

FIGS. 8 and 9 show further alternative securing means 42 in which one member 44 fits into a box 46. The member 44 is raised and lowered by a lever 48.

FIG. 10 is a perspective view of one type of box 46 with an anchor bar 50. FIG. 11 shows an alternative box 52 with an anchor bar 54.

FIG. 12 shows two different designs for the member 44. It will be seen that each member 44 has a hook portion 56 for locating around the anchor bar 50 or 54.

FIG. 13 shows four units of the seating apparatus 2, connected together with the separate units being in modular form to allow the connection. Eight persons 14 are shown seated along one side of the seating apparatus 2. Another eight persons could be seated along the other side of the seating apparatus 2. As can be appreciated from a comparison of FIGS. 1 and 13, the cargo 8 has been removed from the storage area 6 in FIG. 13 in order to provide maximum seating availability.

FIG. 13 also shows schematically in the form of the rectilinear area 58, the survival space that is provided for one of the personsl4 due to the frame 12.

FIG. 14 shows a seat 60 comprising a seat frame 62 and a seat part 64.

FIG. 15 shows the seat 60 of FIG. 14 assembled and being unfolded. The seat 60 being a foldable seat.

FIGS. 16 and 17 show a person 14 sitting on the seat 60. FIG. 16 shows how there is a stowage space 66 underneath the seat. FIG. 17 shows how the seat 60 has a head restraint 68 which is curved to give front-to-back and side-to-side protection for the head of the person 14. FIGS. 16 and 17 both show how the seat 60 is provided with a seat belt 70.

Referring to FIGS. 18, 19 and 20, there is shown part of a frame 72 of seating apparatus of the invention. The frame 72 comprises a top joint 74 and a lower joint 76. The top joint 74 is best seen in FIG. 19. As shown by arrows 78, 90° rotation is allowed by frame members 80. The frame members 80 pivot on pivot pins 82 which extend through mounting plates 84.

The lower joint 76 is best seen from FIG. 20. Frame members 86 can be rotated through 90° as indicated by arrows 88. The rotation of the frame members 86 is permitted by pivot pins 90 extending through a mounting plate 92.

FIG. 21 shows a top joint corner bracing arrangement 94 comprising a removable locking pin 96. Rotation for storage is indicated by arrow 78.

FIG. 22 shows pictorially a seat 98. The seat 98 is held in position by a lower locking pin arrangement 100. The lower locking pin arrangement 100 is best seen from FIG. 23. More specifically, the seat 98 has a seat frame 102 which locates in a main roll over protection frame 12 shown in previous drawings. The seat is secured in position by a locking pin. A spring loaded pin 104 rotates to engage as shown by arrows 106, 108.

FIG. 24 shows a vehicle 110 comprising a driving cab 112 and a flat back 114. It will be seen that two of the frames 72 shown in FIGS. 18-21 have been folded flat so that they can be stored on the flat back 114 with minimum occupation of space. Prior to folding of the frames 72, the seats 98 have been removed by indicated by FIGS. 22 and 23. FIG. 25 shows in detail one of the folded frames 72.

FIG. 26 shows the vehicle 110 having two frames 72. As can be seen, the frame 72 nearest the rear end of the vehicle 110 has a seat 116 for a person 118. The other frame 70 has had its seats removed and it is being used to store pieces of equipment 120 in a secure manner. Positioned between the frames 72 and the driving cab 112 are two containers 122, 124 as shown.

FIG. 27 shows the vehicle 110 with the containers 122, 124 moved to the rear of the vehicle. Positioned between the container 124 and the driving cab 114 are two frames 72. Each frame 72 has had its seats removed, and each frame 72 is being used for securely holding equipment 120.

Referring now to FIGS. 28-34, some vehicles may have flat backs 126 which have sockets 128 for receiving other pieces of equipment. The positioning of the sockets 128 may vary on different truck beds of different vehicles. This may prevent one frame 72 from easily being transferred from one flat back of a vehicle to another flat back of different vehicle. In order to overcome this problem, one or more adaptor sub-frames 130 may be utilised. Each adaptor sub-frame 130 has two legs 132 which locate in two of the sockets 128. Two of the sub-frames 130 are able to hold three of the frames 72.

As can be seen from FIG. 28-34, each sub-frame 130 has two latching devices, 134 for holding the frames 72 in position. As shown in FIG. 30, each latching device 134 comprises a latch 136 mounted on top of a spacer mechanism 138. The latch 136 has a lever 140 which pivots from an unlocked position to a locked position as shown in FIGS. 31-34 in order to clamp the adapter sub-frame 130 to the aperture 128 in the flat back 126 of the vehicle.

Referring now to FIGS. 35 and 36, there is shown part of a backrest 142 comprising an upper channel member 144 and a lower channel member 146. The upper channel member 144 has a slot 148 and the lower channel member 146 has a slot 150. The slot 148 is able to receive an edge 152 of a body portion 154 of the backrest 142. Similarly, the slot 150 is able to receive an edge 156 of the body portion 154. The insertion of the edges 152, 156 in their slots 148, 150 respectively enables the body portion 4 to be turned from the position shown in FIG. 35 to the position shown in FIG. 36 as may be desired. The body portion 154 is thus able to form a reversible seat back panel. As compared with the position shown in FIG. 35, the position shown in FIG. 36 presents a concave part 158 to a back of a user. There is thus an extra depth for padding, or for receiving a back pack, webbing pouches, gas masks or other equipment that need to be kept on a person's back whilst the person is sitting on the seat. The reversible seat arrangement shown in FIGS. 35 and 35 is especially advantageous for military personnel wearing, for example, day back packs and/or body armour means.

It is to be appreciated that the embodiments of the invention described above with reference to the accompanying drawings have been given by way of example only and that modifications may be effected. Thus, for example, the seating apparatus may be arranged to have holder means for holding an object to be carried by a person 14 sitting in the seat 16. The frame 12 is shown to be of an open tubular construction but other constructions may be employed and other shapes for the frame may also be employed.

1. Seating apparatus for use on a vehicle having a flat carrying area, which seating apparatus comprises a frame giving roll over protection to a person seated on the seating apparatus in the event that the vehicle should roll over, at least one seat mounted in the frame, and securing means for releasably securing the seating apparatus on the flat carrying area of the vehicle whereby the seating apparatus is able to be secured on the flat carrying area and removed from the flat carrying area as desired.

2. Seating apparatus according to claim 1 in which the seat is demountable from the frame.

3. Seating apparatus according to claim 2 in which the seat is mounted by a spring bolt mechanism.

4. Seating apparatus according to claim 1 in which the seat is a foldable seat.

5. Seating apparatus according to claim 1 in which the frame is able to receive from one to four of the seats.

6. Seating apparatus according to claim 1 in which the frame is a modular frame which is able to be connected to at least one further similar modular frame.

7. Seating apparatus according to claim 1 in which the securing means secures the frame to the flat carrying area.

8. Seating apparatus according to claim 1 in which the securing means is a quick release securing means.

9. Seating apparatus according to claim 8 in which the securing means is a latch and shackle quick-release securing means.

10. Seating apparatus according to claim 8 in which the securing means is a plug and socket quick release securing means.

11. Seating apparatus according to claim 8 in which the securing means is a hook and socket quick release securing means.

12. Seating apparatus according to claim 1 in which the frame is a foldable frame.

13. Seating apparatus according to claim 1 in which the frame is an open tubular construction.

14. Seating apparatus according to claim 1 and including a stowage space underneath the seat.

15. Seating apparatus according to claim 1 and including holder means for holding an object to be carried by a person sitting in the seat.

16. Seating apparatus according to claim 1 and including lateral restraint means for a person seated on the seat.

17. Seating apparatus according to claim 1 and including a head rest.

18. Seating aparatus according to claim 1 and including a seat belt.

19. A vehicle when provided with seating apparatus according to claim 1.
